(19) United States
(12) Patent Application Publication
(10) Pub. No.: US 2026/0071646 A1
(43) Pub. Date: Mar. 12, 2026

(54) RELIEF CUT WASHER

(71) Applicant: PRIMESOURCE CONSULTING LLC, Herriman, UT (US)

(72) Inventor: John DAVIS, Herriman, UT (US)

(21) Appl. No.: 19/322,893

(22) Filed: Sep. 9, 2025

Related U.S. Application Data
(60) Provisional application No. 63/692,246, filed on Sep. 9, 2024.

(51) Int. Cl. F16B 43/00

(52) U.S. Cl. CPC F16B 43/00

(57) ABSTRACT

A relief cut washer can include an annular section that defines an inner diameter that slidingly receives an associated threaded element therethrough so as to define a socket axis. The annular section can include a first face and a second face that face in opposite directions that cooperate to define a washer thickness. The washer can also include a plurality of lobes that radially extend from the annular section. Each of the lobes can include a peak that defines a maximum radial distance from the socket axis for the relief cut washer. The washer can also include a plurality of ledges that radially extend from the annular section so as to connect the lobes that are adjacent to one another. Each of the ledges can define a ledge thickness that is less than the washer thickness. Further, each of the ledges can define a depression that is non-circular in shape.

### BACKGROUND

Power driven torque tools generate an accurate bolt load through the rotation of a fastener. A reaction washer can be used to provide an abutment means for the tool. In particular, the reaction washer is placed directly below the nut or bolt head being subjected to the intended tightening force. Further, the reaction washer is connected to the tool housing via a reaction socket assembly. This connection ensures that the tightening force generated by the tool is transferred into the fastener and does not merely result in rotation of the tool around the axis of the fastener.

However, there are difficulties associated with these tools and traditional reaction washers. For example, the reaction washer and reaction socket assembly may need to be used in a horizontal or inverted position. When these orientations are present, the connection between the reaction washer and reaction socket can be compromised. Traditional reaction washers do not provide a positive connection means to the reaction socket allowing for a safe, hands-free operation of the power driven torque tool. Further, the reaction socket might not mate with the corresponding power-driven torque tool due to connection differences between the power driven torque tool body and the receiving end of the reaction socket. Furthermore, many reaction washers do not sufficiently engage with the reaction socket assembly thus inducing damage to the reaction washer, requiring the reaction washer to be deemed a single use item. As such, a better washer is needed.

### SUMMARY

According to an aspect, a relief cut washer can include an annular section that defines an inner diameter that slidingly receives an associated threaded element therethrough so as to define a socket axis. The annular section can include a first face and a second face that face in opposite directions that cooperate to define a washer thickness. The washer can also include a plurality of lobes that radially extend from the annular section. Each of the lobes can include a peak that defines a maximum radial distance from the socket axis for the relief cut washer. The washer can also include a plurality of ledges that radially extend from the annular section so as to connect the lobes that are adjacent to one another. Each of the ledges can define a ledge thickness that is less than the washer thickness.

According to an aspect, a relief cut washer can include an annular section that defines an inner diameter that slidingly receives an associated threaded element therethrough so as to define a socket axis. The annular section can include a first face and a second face that face in opposite directions that cooperate to define a washer thickness. The washer can also include a plurality of lobes radially extending from the annular section. Each of the lobes can include a peak that defines a maximum radial distance from the socket axis for the relief cut washer. The washer can also include a plurality of ledges that radially extend from the annular section so as to connect the lobes that are adjacent to one another. Each of the ledges can define a depression that is non-circular in shape.

### BRIEF DESCRIPTION OF THE DRAWINGS

FIG. 1 is a perspective view of a reaction washer assembly and relief cut washer in an operating environment;

FIG. 2 is an exploded perspective view of the reaction washer assembly of FIG. 1;

FIG. 3 is a top plan view of the relief cut washer;

FIG. 4 is a bottom plan view of the relief cut washer;

FIG. 5 is a perspective view of the relief cut washer;

FIG. 6A is an elevation view of the relief cut washer; and

FIG. 6B is an enlarged view of a portion of the relief cut washer.

FIG. 6C is an enlarged view of a portion of the relief cut washer of FIG. 6A.

FIG. 6D is section view of the relief cut washer along lines FIG. 6D-FIG. 6D of FIG. 6A.

### DETAILED DESCRIPTION

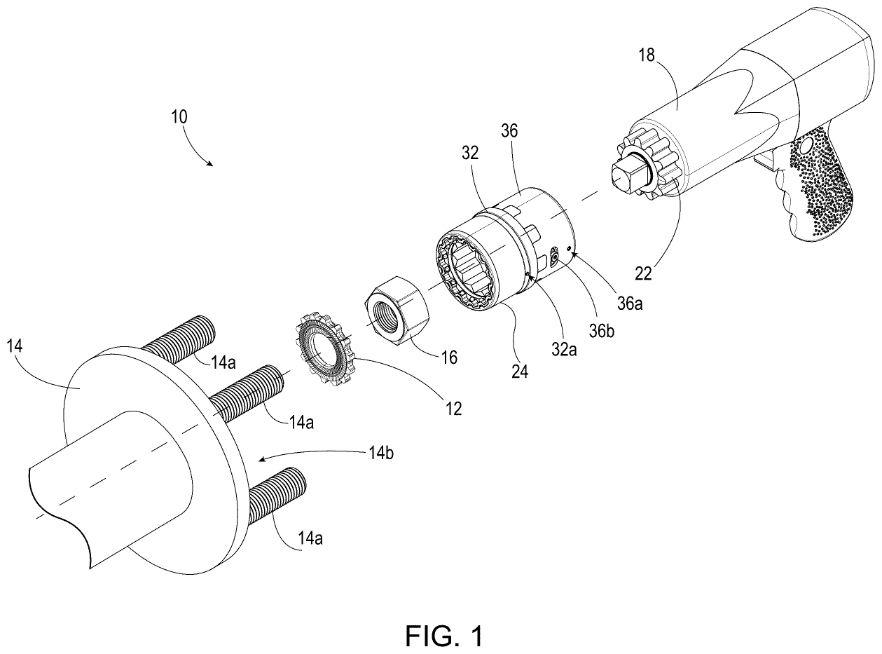

With reference to FIG. 1, a reaction socket assembly 10 can be used with a variety of components to engage a relief cut washer 12 that is slidingly received on associated threaded element 14a that contacts a flange face 14b of a flange assembly 14 and an associated nut 16 that is threadingly received on the associated threaded element 14a.

As illustrated, the reaction socket assembly 10 can be used with an associated torque tool 18 that includes an engagement point 22 to engage the relief cut washer 12 and nut 16. The threaded element 14a could be part of a bolt or stud that is threadingly engaged by the nut 16. The relief cut washer 12 is disposed on the threaded element 14a so that the nut 16 is between the relief cut washer 12 and the free end of the threaded element 14a along the socket axis 38 so as to engage the torque tool 18 as will be described in more detail hereinafter.

Notably, the relief cut washer 12 can slidingly and coaxially receive the threaded element 14a and the nut 16 can threadingly and coaxially receive the threaded element 14a, both along the socket axis 38. As noted hereinbefore, the torque tool 18 can be utilized to tighten or loosen the nut 16. As will be appreciated, this means that the nut 16 would travel along the threaded element 14a toward the free end of the threaded element 14a when the nut 16 is being loosened so that the nut 16 could be removed from the threaded element 14a and the nut 16 would travel along the threaded element 14a away from the free end of the threaded element 14a when the associated threaded element 14a is being tightened so that the nut 16 cannot be removed from the threaded element 14a.

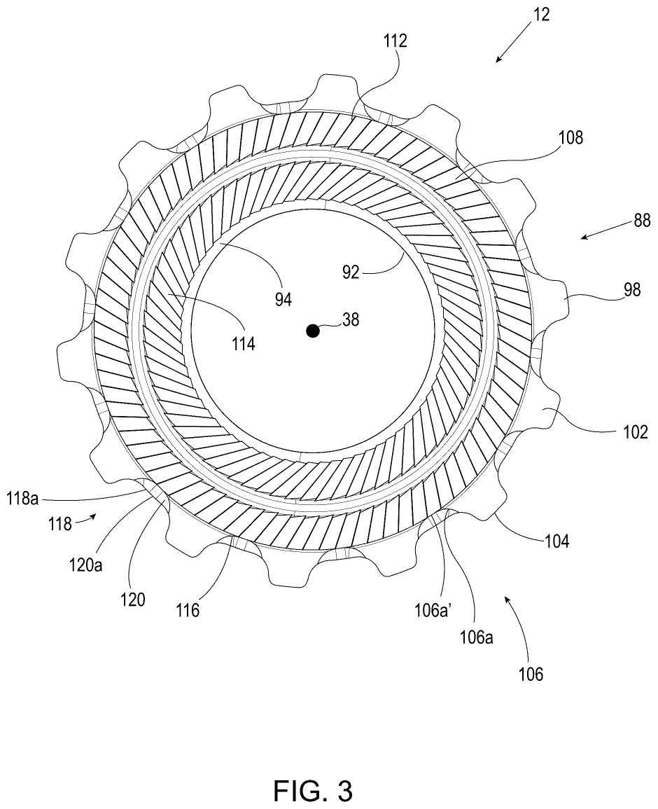

The flange 14 either receives or is attached to the threaded element 14a distal to the free end so as to provide a surface to which the relief cut washer 12 and the nut 16 can be tightened (i.e., preventing linear movement of the relief cut washer 12 and the nut 16 along the socket axis 38 away from the free end). Further, as will be described in more detail hereinafter, serrations 112 (FIG. 3) of the relief cut washer 12 prevent rotation of the relief cut washer 12 around the threaded element 14a.

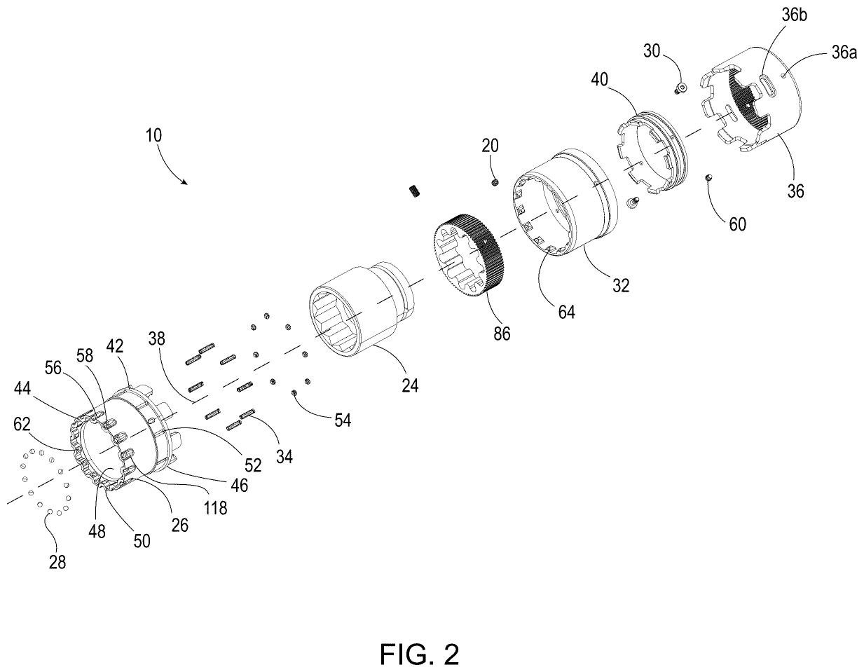

As shown in FIG. 2, the reaction socket assembly 10 includes the socket 24, a lower part 26, a plurality of keys 28, and a sleeve 32. Additionally, the reaction socket assembly 10 can also include at least one resiliently resistive element 34, a drive cap 36, and a locking sleeve 40.

The socket 24 is configured to slidingly engage the associated nut 16 so as to define a socket axis 38. As will be appreciated, the socket 24 would rotate about the socket axis 38 when driven by the torque tool 18. As such, the socket 24 engages the associated nut 16 for paired rotational movement. The socket 24 is configured to rotationally move independent of the lower part 26. As illustrated, the socket 24 defines a generally cylindrical outer diameter and is a 12-point socket. However, it will be appreciated that other shapes are possible and contemplated without departing from the scope of this disclosure.

The lower part 26 can be disposed coaxially exterior to the socket 24. The lower part 26 can have a generally cylindrical shape with a top 42 and a bottom 44 disposed at opposite ends thereof along the socket axis 38. The lower part 26 can also include a lip 46 that circumferentially extends around the top 42 of the lower part 26.

The lower part 26 can define a lower part inner diameter surface 48 and a plurality of slots 50. The slots 50 can extend primarily in a direction parallel to the socket axis 38. Further, the slots 50 can be disposed within the lower part 26 and adjacent the bottom 44 of the lower part 26. The slots 50 can extend from the bottom 44 toward the top 42.

It is envisioned that the slots 50 will only extend partially upward toward the top 42 a distance that is approximately equal to the thickness of the relief cut washer 12. However, it will be appreciated that that the length of the slots 50 could be of a variety of lengths without departing from the scope of this disclosure. As will be described in more detail hereinafter, the slots 50 of the lower part 26 engage the lobes 102 of the relief cut washer 12. This engagement provides for improved operation of the relief cut washer 12 and the reaction socket assembly 10. Notably, the ledges 118 and the lobes 102 load share a rotational force induced into the relief cut washer 12 so as to provide a major diameter load distribution and a minor diameter load distribution of forces.

The slots 50 of the lower part 26 can engage the relief cut washer 12. The lower part 26 can also define a plurality of open channels 52 that extend in a direction generally parallel to the socket axis 38 for receipt of the least one resistive element 34. As will be appreciated, the open channels 52 are sized to allow at least partial receipt of the at least one resistive element 34. Notably, the open channels 52 can be sized such that a radial portion of the resistive element 34 is not received within the open channels 52 so that the sleeve 32 and the lower part 26 can be biased away from one another. The at least one resistive element 34 can be retained within the open channels 52 with a cover 54 that may be threaded or otherwise affixed to the lower part 26.

The lower part 26 can also define a plurality of recesses 56 and a plurality of keyways 58. As illustrated, the recesses 56 and keyways 58 are disposed near the bottom 44 of the lower part 26 and are radially disposed about the lower part 26. Further, the recesses 56 can extend primarily in a direction parallel to the socket axis 38 and the keyways 58 can extend primarily in a direction radially extending toward the socket axis 38.

The plurality of recesses 56 are fluidly connected with the respective plurality of keyways 58. Additionally, the plurality of keyways 58 fluidically connect the sleeve 32 and the socket 24. The lower part inner diameter surface 48 defines a plurality of engagement ports 62 in direct fluid communication with the respective keyways 58. More particularly, the engagement ports 62 can serve as a fluidic gateway to the keyways 58. Further, the engagement ports 62 can be sized to limit radial travel of the keys 28 toward the socket axis 38.

As illustrated, the keys 28 are generally spherical in shape. The spherical shape allows the keys 28 to smoothly and precisely move within the recesses 56 and the keyways 58 for enhanced engagement with the relief cut washer 12. However, it will be appreciated that other shapes are possible without departing from the scope of the disclosure. As will be discussed in more detail hereinafter, the plurality of keys 28 can at least partially extend radially inward toward the socket axis 38 when a respective plurality of ramps 64 of the sleeve 32 are received in the respective plurality of recesses 56 of the lower part 26. However, as was previously noted, the size of the engagement ports 62 limit the radial movement of the keys 28 toward the socket axis 38.

With reference to FIGS. 1-2, the drive cap 36 can define an upper set screw bore 36a that allows passage of a set screw 20 therethrough for engagement with the locking sleeve 40. As illustrated, there are a plurality of upper set screw bores 36a and they radially extend through the drive cap 36 toward the socket axis 38. This engagement ensures that the drive cap 36 and the insert 86 remain attached to one another.

The drive cap 36 can also define a cap slot 36b that allows passage of shoulder bolt 30 therethrough for engagement with the locking sleeve 40. There can include a single or a plurality of cap slots 36b, and hence a single or a plurality of shoulder bolts 30, without departing from the scope of the disclosure. This engagement ensures that the drive cap 36 and the locking sleeve 40 remain attached to one another.

The drive cap 36 can include an upper end 76 and a lower end 78 disposed at opposite ends. The lower end 78 is adjacent the sleeve 32 and the first end 68 is adjacent the lower end 78. The upper end 76 of the drive cap 36 and the second end 72 of the sleeve 32 are disposed at opposite ends of the reaction socket assembly 10 so as to define terminal ends of the reaction socket assembly 10.

The upper end 76 of the drive cap 36 can define an upper inner diameter surface 82 that slidingly engages the associated torque tool 18 to prevent rotation of the drive cap 36 with respect to the associated torque tool 18. The upper inner diameter surface 82 can define an upper cap shape and an upper cap size.

The upper cap shape and the upper cap size can be the same as the sleeve shape and the sleeve size, respectively. As illustrated, the drive cap 36 includes a primary portion 84 and an insert 86. The insert 86 can be circumferentially surrounded by the primary portion 84, with the insert 86 and the primary portion 84 being connected to one another via a splined connection. The insert 86 can be removed and replaced by other differing interior geometry inserts to match the connection geometry of other tool housings. Thus, the upper inner diameter surface 82 can receive a variety of inserts 86 to allow compatibility with different torque tool brands.

The reaction socket assembly 10 provides numerous advantages. For example, the reaction socket assembly 10 allows the torque tool 18 to be used in a variety of orientations that would otherwise not be possible. Notably, there are several environments in which the torque tool 18 could not be safely used when the fastener assembly is inverted. Such orientation would require the user to manually hold the torque tool 18 and reaction socket assembly 10 flush against the relief cut washer 12 to maintain sufficient mating.

Additional limitations can occur when the torque tool 18 and reaction socket assembly 10 are placed horizontally against the face of the relief cut washer 12. With the weight of larger versions of the torque tool 18 and reaction socket assembly 10 exceeding 100 pounds, the ability to maintain a perpendicular orientation to the flange face and relief cut washer 12 can cause the engagement of the reaction socket assembly 10 and relief cut washer 12 to become misaligned and only partially engaged, thus damaging the relief cut washer 12 and reaction socket assembly 10.

As shown in FIG. 3, a relief cut washer 12 includes an annular section 88, a plurality of lobes 102, a plurality of ledges 118, and an engagement ring 108 including a plurality of serrations 112. Initially, it is noted that the relief cut washer 12 is shown with fourteen lobes 102 and fourteen ledges 118. However, there could be more or less lobes and ledges without departing from the scope of this disclosure. Further, it will be understood that any discussion relating to an individual element (e.g., lobe, ledge) is applicable to all of the same elements. Furthermore, to aid in clarity, the figures have been numbered such that only one of the respective elements is identified, instead of all of the elements. For example, only a single lobe 102 is identified on FIG. 3. However, it will be understood that the accompanying description herein is applicable to all of the lobes 102 of the relief cut washer 12 (i.e., all fourteen lobes 102).

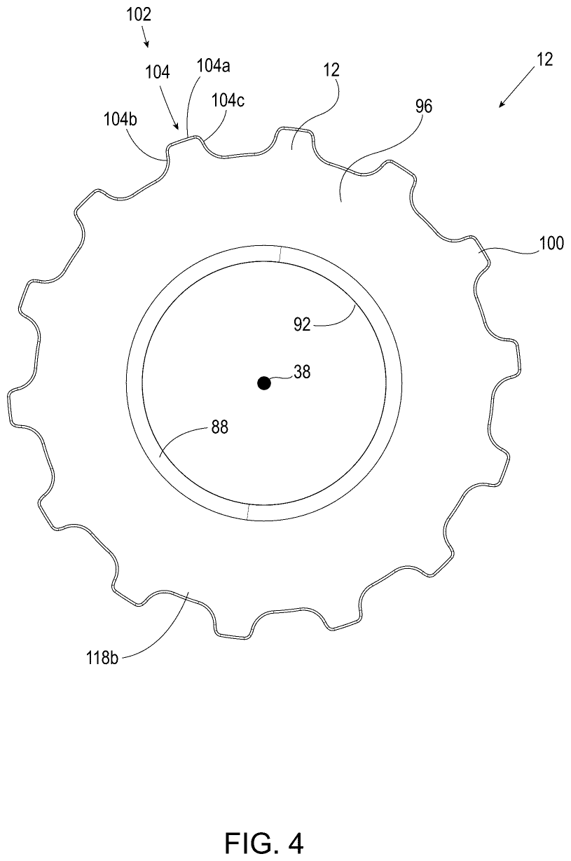

With attention to FIGS. 1 and 3-5, the annular section 88 defines an inner diameter 92 that slidingly receives an associated threaded element therethrough so as to define a socket axis 38. The annular section 88 includes a first face 94 and a second face 96 that face in opposite directions that cooperate to define a washer thickness. The serrations 112 of the engagement ring 108 can extend from the first face 94. However, it will be understood that the serrations 112 could also, or instead of, extend from the second face 96.

As will be described in more detail hereinafter, the plurality of serrations 112 extend from the first face 94 in a direction that is away from a direction that a depression 120 extends into the ledge 118. There can be one or more engagement rings extending from the annular section 88 without departing from the scope of the disclosure. For example, the annular section 88 can include the engagement ring 108 and a secondary engagement ring 114.

As illustrated, the secondary engagement ring 114 is disposed radially inward from engagement ring 108. The serrations 112 prevent slipping and allow for effective transfer of reaction torque onto the surface (i.e., flange face 14b) onto which the nut 16 is being tightened. Because of the serrations 112, the relief cut washer 12 will not slip and spin when the torque tool 18 starts to apply torque to the nut 16 and/or bolt head while withholding itself via the socket 24 on the relief cut washer 12.

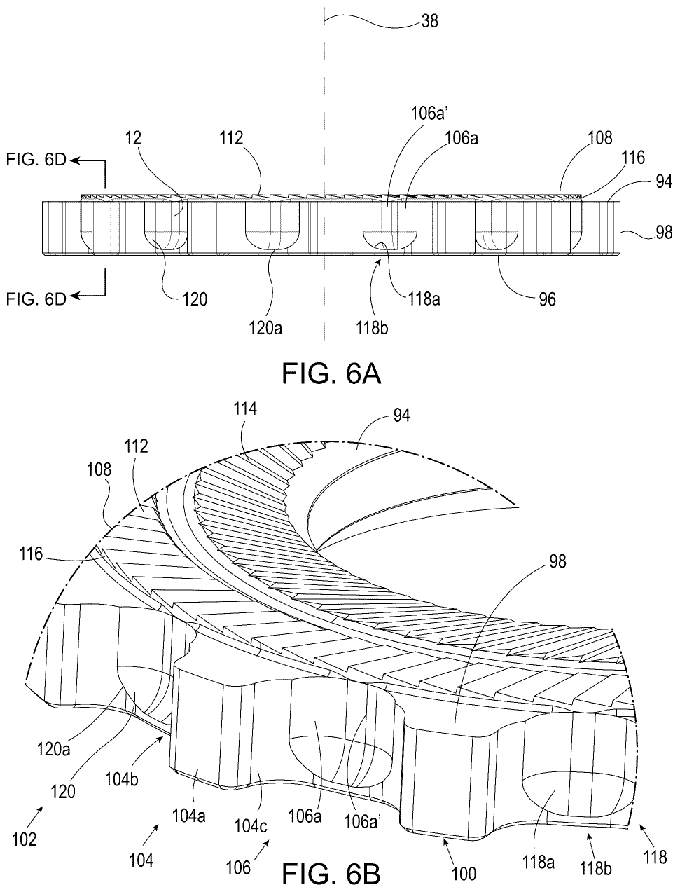

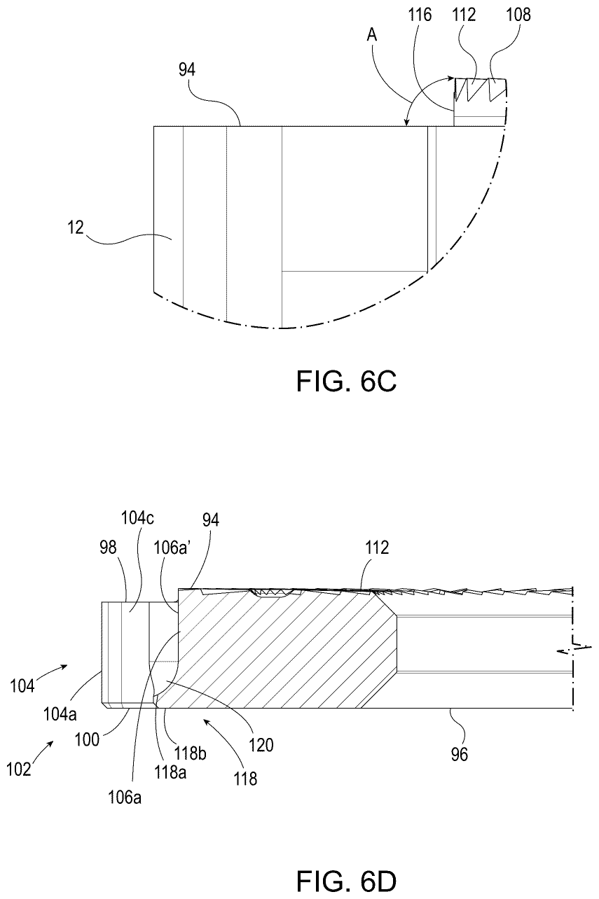

As shown in FIGS. 6A and 6B, the engagement ring 108 can include an engagement ring outer diameter surface 116 that defines an engagement ring outer diameter. The plurality of serrations 112 can extend from the first face 94 such that an included angle A between the engagement ring outer diameter surface 116 and the first face 94 is equal to 90 degrees. This non-tapered arrangement provides for improved engagement between the relief cut washer 12 and the mating surface of the flange or other element to which contact is made.

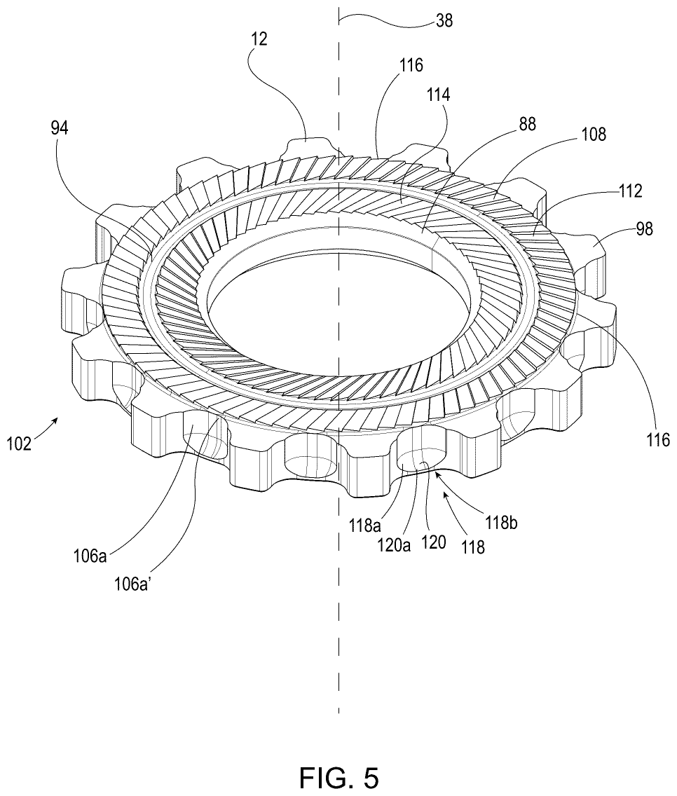

Referring back to FIGS. 5 and 6, the plurality of lobes 102 radially extend from the annular section 88. Each of the lobes 102 includes a peak 104 that defines a maximum radial distance from the socket axis 38 for the relief cut washer 12. Further, each of the lobes 102 can include a valley 106 including a valley surface 106a. The lobes 102 can engage with the lower part 26 of the torque tool 18 to prevent rotation between the relief cut washer 12 and the lower part 26 of the torque tool 18.

The valley surface 106a can include a root 106a′ that defines a minimum radial distance from the socket axis 38 for the relief cut washer 12. The outer engagement ring 108 defines an outer engagement ring outer diameter 116 that is radially spaced from the socket axis 38 a distance that is equal to a radial distance between the socket axis 38 and the root 106a′ of the valley surface 106a of the valley 106. Each of the peaks 104 of each of the lobes 102 can be disposed on a peak face 104a of the respective lobes 102 and the peak face 104a of each of the peaks 104 can face radially away from the socket axis 38 so as to be orthogonal to a line radially extending outward from the socket axis 38.

With special attention to FIG. 6B, each of the peaks 104 of each of the lobes 102 can be radially flanked by a first inner face 104b and a second inner face 104c that each extend from the respective peak face 104a toward the valley surface 106a in a curved manner when viewed in a direction along the socket axis 38. Also, a curvature of the valley surface 106a is different than a curvature of the first inner face 104b and the second inner face 104c. Each of the lobes can include a first lobe face 98 and a second lobe face 100 that face in opposite directions that cooperate to define a lobe thickness. Each of the valley surfaces 106s defines a radial valley dimension and a circumferential valley dimension. The circumferential valley 106 dimension of one of the valleys 106 is greater than the radial valley dimension of one of the valleys 106.

The valley surface 106a defines a valley surface 106a of curvature about an axis that is parallel to the socket axis 38 and the first inner face 104b defines a first inner face 104b of curvature about an alternative axis that is parallel to the socket axis 38. Further, the valley surface 106a of curvature can be different from the first inner face 104b of curvature. Additionally, the second inner face 104c defines a second inner face 104c of curvature about an other axis that is parallel to the socket axis 38. Further still, the second inner face 104c of curvature can be equal to the first inner face 104b of curvature.

The plurality of ledges 118 radially extend from the annular section 88 so as to connect the lobes 102 that are adjacent to one another. Each of the plurality of ledges 118 can include a first ledge face 118a and a second ledge face 118b that face in opposite directions to define a ledge thickness. The ledge thickness can be less than the washer thickness. Further, the lobe thickness can be greater than the ledge thickness. Additionally, the second ledge face 118b and the second face 96 of the annular section 88 can be coplanar in a plane that is orthogonal to the socket axis 38.

Further, each of the ledges 118 can define a depression 120 that is configured for receipt of the key of an associated socket. For reference, the key 28 of the socket 24 was shown in FIG. 2, which is an exploded partial view of FIG. 1.

As shown in FIGS. 2, 5, and 6, each of the depressions 120 defines a concave curvature. The depression 120 can be circumferentially bounded by the valley surface 106a on a portion of a perimeter 120a of the depression 120 and can be free on a remaining portion of the perimeter 120a of the depression 120. Further, the depression 120 can be non-circular in shape. Each of the depressions 120 of each of the plurality of ledges 118 defines a radial dimension and a circumferential dimension. The circumferential dimension of one of the depressions 120 is greater than the radial dimension of one of the depressions 120 and a portion of a perimeter 120a of the depression 120 cooperates with the valley surface 106a to define a radial transition.

With continued attention to the ledge 118 and depression 120, it is noted that the ledge thickness is variable. In particular, the ledge thickness defines a ledge thickness minimum at a perimeter 120a of the depression 120. Further, the second ledge face 118b and the second face 96 of the annular section 88 are coplanar in a plane that is orthogonal to the socket axis 38.

The aforementioned relief cut washer 12 has numerous advantages over the prior reaction washers. For example, because of the recited geometry, the washer 12, and hence, the ledge 118a of the relief cut washer 12 can be cold formed and with a single-sided forming process. In particular, the top of the washer 12 is coined for bolt head clearance and then progressively stamped for the depression 120, the valleys 106, the serrations 112, and radial surfaces.

As will be appreciated, cold forming is when a metal blank is pressed between stamping dies at room temperature to impress a desired design and form a coin-shaped part. Such a process allows components to be made to extremely close tolerances and with intricate designs. This is especially useful with the present relief cut washer 12 with the previously identified elements.

Further, the ledge 118a and the peak 104 can be produced with a die that has rounded corners. As such, the serviceable lifespan of the die is improved, resulting in reduced manufacturing costs for the relief cut washer 12. Further, the radial transition between the valley surface 106a and either the first inner face 104b or the second inner face 104c provides for increased strength of the peak 104, namely in deformation resistance when tightening or loosing operations are being performed.

As noted hereinbefore, the location of the depression 120 is the same center line location of the key 28 during combination of the elements. As such, the relief cut washer 12 can be used with a variety of reaction sockets without modifications to connect and function with the washer 12.

Further, the radial transition between the valley 106 and the peak 104 ensures that the peaks 104 remain supported and reinforced without the introduction of a stress riser location. Additionally, the ledges 118 help to retain rigidity of the washer 12 and provide a good location for the depression 120 for containing the key 28. With the depression 120 being of an oval or oblong shape, the lock on tolerance for the key 28 can be a non-critical dimension. Accordingly, the positioning for the connection to the washer 12 and load path is left to the peaks 104.

A relief cut washer has been described above with particularity. Modifications and alterations will occur to those upon reading and understanding the preceding detailed description. The invention, however, is not limited to only the embodiments described above. Instead, the invention is broadly defined by the appended claims and the equivalents thereof.

1. A relief cut washer, comprising:
an annular section defining an inner diameter that slidingly receives an associated threaded element therethrough so as to define a socket axis, the annular section including a first face and a second face that face in opposite directions that cooperate to define a washer thickness;
a plurality of lobes radially extending from the annular section, each of the lobes including a peak that defines a maximum radial distance from the socket axis for the relief cut washer; and
a plurality of ledges that radially extend from the annular section so as to connect the lobes that are adjacent to one another, each of the ledges defining a ledge thickness that is less than the washer thickness.

2. The relief cut washer of claim 1, wherein each of the plurality of ledges includes a first ledge face and a second ledge face that face in opposite directions to define the ledge thickness, and wherein the second ledge face and the second face of the annular section are coplanar in a plane that is orthogonal to the socket axis.

3. The relief cut washer of claim 1, wherein each of the ledges defines a depression configured for receipt of an associated key of an associated socket, the depression defining a concave curvature.

4. The relief cut washer of claim 3, further comprising an engagement ring including a plurality of serrations extending from the first face, the plurality of serrations extending from the first face in a direction that is away from a direction that the depression extends into the ledge.

5. The relief cut washer of claim 1, wherein each of the lobes comprises a valley including a valley surface, the valley surface including a root that defines a minimum radial distance from the socket axis for the relief cut washer.

6. The relief cut washer of claim 5, further comprising an outer engagement ring that defines an outer engagement ring outer diameter that is radially spaced from the socket axis a distance that is equal to a radial distance between the socket axis and the root of the valley surface of the valley.

7. The relief cut washer of claim 5, wherein each of the peaks of each of the lobes is disposed on a peak face of the respective lobe, and wherein the peak face of each of the peaks faces radially away from the socket axis so as to be orthogonal to a line radially extending outward from the socket axis.

8. The relief cut washer of claim 7, wherein each of the peaks of each of the lobes is radially flanked by a first inner face and a second inner face that each extend from the respective peak face toward the valley surface in a curved manner when viewed in a direction along the socket axis.

9. The relief cut washer of claim 8, wherein a curvature of the valley surface is different than a curvature of the first inner face and the second inner face.

10. The relief cut washer of claim 5, wherein each of the ledges defines a depression that is circumferentially bounded by the valley surface on a portion of a perimeter of the depression and is free on a remaining portion of the perimeter of the depression.

11. A relief cut washer, comprising:
an annular section defining an inner diameter that slidingly receives an associated threaded element therethrough so as to define a socket axis, the annular section including a first face and a second face that face in opposite directions that cooperate to define a washer thickness;
a plurality of lobes radially extending from the annular section, each of the lobes including a peak that defines a maximum radial distance from the socket axis for the relief cut washer; and
a plurality of ledges that radially extend from the annular section so as to connect the lobes that are adjacent to one another, wherein each of the ledges defines a depression that is non-circular in shape.

12. The relief cut washer of claim 11, wherein each of the ledges defines a depression configured for receipt of an associated key of an associated socket, the depression defining a concave curvature.

13. The relief cut washer of claim 12, wherein each of the depressions of each of the plurality of ledges defines a radial dimension and a circumferential dimension, and wherein the circumferential dimension of one of the depressions is greater than the radial dimension of one of the depressions.

14. The relief cut washer of claim 12, wherein each of the lobes comprises a valley including a valley surface, the valley surface including a root that defines a minimum radial distance from the socket axis for the relief cut washer, and wherein a portion of a perimeter of the depression cooperates with the valley surface to define a radial transition.

15. The relief cut washer of claim 12, wherein each of the plurality of ledges includes a first ledge face and a second ledge face that face in opposite directions to define a ledge thickness, and wherein the second ledge face and the second face of the annular section are coplanar in a plane that is orthogonal to the socket axis.

16. The relief cut washer of claim 15, wherein the ledge thickness is variable such that the ledge thickness defines a ledge thickness minimum at a perimeter of the depression.

17. The relief cut washer of claim 15, wherein each of the lobes includes a first lobe face and a second lobe face that face in opposite directions that cooperate to define a lobe thickness, and wherein the lobe thickness is greater than the ledge thickness.

18. The relief cut washer of claim 12, wherein each of the lobes comprises a valley including a valley surface, the valley surface including a root that defines a minimum radial distance from the socket axis for the relief cut washer, wherein each of the peaks of each of the lobes is disposed on a peak face of the respective lobe, and wherein of each of the valley surfaces defines a radial valley dimension and a circumferential valley dimension, and wherein the circumferential valley dimension of one of the valleys is greater than the radial valley dimension of one of the valleys.

19. The relief cut washer of claim 18, wherein each of the peaks of each of the lobes is radially flanked by a first inner face and a second inner face that each extend from the respective peak face toward the valley surface in a curved manner when viewed in a direction along the socket axis, wherein the valley surface defines a valley surface of curvature about an axis that is parallel to the socket axis and the first inner face defines a first inner face of curvature about an alternative axis that is parallel to the socket axis, and wherein the valley surface of curvature is different from the first inner face of curvature.

20. The relief cut washer of claim 19, wherein the second inner face defines a second inner face of curvature about an other axis that is parallel to the socket axis, and wherein the second inner face of curvature is equal to the first inner face of curvature.
